(19) United States
(12) Patent Application Publication
(10) Pub. No.: US 2003/0169703 A1
(43) Pub. Date: Sep. 11, 2003

(54) Mobile communication terminal apparatus, cell search control method therefor, and program

(75) Inventor: Koichi Tamura, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/377,744

(22) Filed: Mar. 4, 2003

(30) Foreign Application Priority Data
Mar. 6, 2002 (JP) 059641/2002

(51) Int. Cl. H04B 7/216

(52) U.S. Cl. 370/320

(57) ABSTRACT

This invention relates to a mobile communication terminal apparatus which is used as a mobile station in a cellular mobile communication system using the CDMA scheme, a cell search method, and a program for causing a computer to execute the method. The mobile communication terminal apparatus of the invention includes a determination condition control section which variably controls a determination condition for active cell determination in a cell search in accordance with the moving state of the apparatus.

### BACKGROUND OF THE INVENTION

1. Field of the Invention

The present invention relates to a mobile communication terminal apparatus, a cell search control method therefore, and a program and, more particularly, to a mobile communication terminal apparatus which is used in a cellular mobile communication system and performs a cell search.

2. Description of the Prior Art

In a cellular mobile communication system using the CDMA (Code Division Multiple Access) scheme, a mobile station performs handover by communicating with a plurality of cells, thereby realizing communication without interruption under a mobile communication environment. This function is an important merit of CDMA communication. It is important for a mobile station to perform a proper cell search.

A conventional cell search processing apparatus and cell search method in a mobile station used in a cellular mobile communication system using the CDMA scheme will be described below.

FIG. 1 shows the arrangement of part (a cell search processing section for performing a cell search) of a conventional demodulation circuit in the mobile station used in the cellular mobile communication system using the CDMA scheme. Referring to FIG. 1, the cell search processing section has a delay profile calculating section 1, scrambling code/scrambling timing detecting section 2, scrambling code generating section 3, and active cell determining section 4.

Referring to FIG. 1, the I and Q component signals obtained by quadrature detection and demodulation are input to the delay profile calculating section 1. The delay profile calculating section 1 calculates a delay profile by sequentially performing correlation detection between an input signal and each of a plurality of candidate scrambling codes sequentially generated by the scrambling code generating section 3 on the basis of the detection result obtained by the scrambling code/scrambling timing detecting section 2.

More specifically, the delay profile calculating section 1 calculates a delay profile by sequentially performing correlation detection between each of a plurality of candidate scrambling codes and a common pilot channel (CPICH) on which a synchronization channel (SCH) in each reception signal is code-multiplexed. The delay profile calculating section 1 outputs the obtained delay profile to the scrambling code/scrambling timing detecting section 2 and active cell determining section 4.

The scrambling code/scrambling timing detecting section 2 detects a scrambling code and scrambling timing by searching for a correlation peak level from the delay profile obtained by the delay profile calculating section 1. The scrambling code/scrambling timing detecting section 2 notifies the active cell determining section 4 of the detected scrambling code and scrambling timing.

The active cell determining section 4 calculates the reception power level (correlation peak power level) of a reception signal from the cell (determination target cell) indicated by the scrambling code notified from the scrambling code/scrambling timing detecting section 2 on the basis of the delay profile obtained by the delay profile calculating section 1. The active cell determining section 4 compares the obtained reception power level with a predetermined threshold to check whether the determination target cell detected on the basis of the reception signal is a cell (active cell) to which the mobile station should connects a radio link. In addition, every time the active cell determining section 4 performs determination, it notifies a cell transition control section (not shown) for controlling cell transition processing of the determination result, and holds it.

If base stations in the cellular mobile communication system are divided into sectors by using a plurality of directional antennas, each sector will be referred to as a cell.

An active cell determination method in the active cell determining section 4 shown in FIG. 1 will be described next.

FIG. 2 is a flow chart showing the operation of the active cell determining section 4 shown in FIG. 1. Referring to FIGS. 2 and 6, first of all, the active cell determining section 4 calculates a reception power level Prx of a common pilot channel of a determination target channel by using the delay profile calculated by the delay profile calculating section 1 (step S11). The obtained reception power level Prx is compared with a predetermined reception power level threshold Pth (step S12).

If the reception power level Prx is equal to or more than the threshold Pth (YES in step S12), the active cell determining section 4 refers to the held determination result to check whether the determination target cell has already been determined as an active cell (step S13). If the determination target cell has already been determined as an active cell (YES in step S13), the active cell determining section 4 determines that the determination target cell as an active cell, and holds this determination result. The active cell determining section 4 also notifies the cell transition control section of the result, and resets an inactive determination count for this determination target cell (step S14).

If it is determined in step S13 that the determination target cell is not an active cell (NO in step S13), the active cell determining section 4 increments an active determination count for this determination target cell by one (step S15), and compares the active determination count with a predetermined forward protection stage count N (step S16).

If the active determination count value for the determination target cell is equal to or more than the forward protection stage count N (YES in step S16), since it indicates that the reception power level Prx of the common pilot channel of the determination target cell has consecutively become equal to or more than the threshold Pth N times or more, the active cell determining section 4 determines the determination target cell as an active cell. The active cell determining section 4 then holds this determination result and notifies the cell transition control section of the result (step S17). In addition, the active cell determining section 4 resets the active determination count and inactive determination count for this determination target cell (step S17).

If it is determined in step S16 that the active determination count value of the determination target cell is smaller than the forward protection stage count N (NO in step S16), the active cell determining section 4 does not determine the determination target cell as an active cell but determines it as an active cell candidate. The active cell determining section 4 then holds this determination result and notifies the cell transition control section of the result (step S18) Note that the active cell determining section 4 holds the active determination count value for this determination target cell without resetting it to use it when the determination target cell becomes a determination target cell again.

If it is determined in step S12 that the reception power level Prx is less than the threshold Pth (NO in step S12), the active cell determining section 4 checks whether the determination target cell has already been determined as an active cell (step S19) as in step S13. If the determination target cell has already been determined as an active cell (YES in step S19), the active cell determining section 4 increments the inactive determination count for this determination target cell by one (step S20), and compares the inactive determination count value with the backward protection stage count M (step S21).

If the inactive determination count value for the determination target cell is smaller than the backward protection stage count M (YES in step S21), since it indicates that the reception power level Prx of the common pilot channel of the determination target cell that has already been determined as an active cell has not consecutively fallen below the threshold Pth M or more times, the active cell determining section 4 determines the determination target cell as an active cell. The active cell determining section 4 then holds this determination result and notifies the cell transition control section of the result (step S22). Note that the active cell determining section 4 holds this inactive determination count value for this determination target cell without resetting it to use it when the determination target cell becomes a determination target cell again.

If it is determined in step S19 that the determination target cell is not determined as an active cell (NO in step S19), since it indicates that the reception power level Prx of the determination target cell is lower than the threshold Pth and the determination target cell has been determined as an inactive cell or active cell candidate by the preceding determination, the active cell determining section 4 determines the determination target cell as an inactive cell (step S23) The active cell determining section 4 holds this determination result, notifies the cell transition control section of the result, and resets the active determination count for this determination target cell (step S23).

If it is determined in step S21 that the inactive determination count value for the determination target cell is larger than the backward protection stage count M (NO in step S21), since it indicates that the reception power level Prx of the determination target cell that has already been determined as an active cell has consecutively fallen below the threshold Pth M times or more, the active cell determining section 4 determines the determination target cell as an inactive cell. The active cell determining section 4 then holds this determination result and notifies the cell transition control section of the result (step S23).

Assume that a given cell has already been determined as an active cell, i.e., recognized as an active cell. In this case, if another cell becomes a determination target cell and is determined as an active cell in step S17, the active cell determining section 4 recognizes both the given cell and another cell as active cells. As described above, in some cases, a plurality of active cells exist.

According to the above active cell determination method in a cell search, a given cell may be erroneously determined as an active cell to degrade communication quality and increase power consumption. If, for example, the reception power level Prx of a determination target cell which has already been determined as an active cell consecutively falls below the threshold Pth M times or more due to temporary variations in radio propagation condition, this determination target cell is determined as not an active cell and recognized as an inactive cell. Even in such a case, if the moving state of the mobile station is a stop/slow moving state, i.e., is at a stop or slowing moving, the mobile station is likely to exist in this determination target cell. If, therefore, this determination target cell is determined as an inactive cell due to temporary variations in radio propagation condition in spite of the fact that the mobile station is at a stop or slowly moving, a deterioration in communication quality and an increase in power consumption will occur.

In mobile communication, in general, communication target cells for a mobile station are sequentially switched. If a cell (active cell) to which a mobile station should connect a radio link is erroneously determined in a cell search, the mobile station connects a radio link to the cell erroneously determined as an active cell in the cell search and communicates with it, resulting in a deterioration in communication quality. Since this deterioration in communication quality makes it necessary for the mobile station to increase the transmission power, the power consumption increases.

### SUMMARY OF THE INVENTION

The present invention has been made in consideration of the above situation, and has as its object to provide a mobile communication terminal apparatus which can hold high communication quality and reduce power consumption, a cell search control method for the apparatus, and a program.

According to the present invention, the moving state of a mobile station is identified, and a determination condition for active cell determination in a cell search is variably controlled in accordance with the identified moving state of the mobile station, thereby suppressing the occurrence of active cell determination errors, holding high communication quality, and reducing power consumption.

In order to achieve the above object, according to the first aspect of the present invention, there is provided a mobile communication terminal apparatus which is used as a mobile station in a cellular mobile communication system using a CDMA scheme, and executes a cell search (active cell determination) to determine whether a cell (determination target cell) detected on the basis of a reception signal is an active cell to which the apparatus should connect a radio link, comprising determination condition control means for variably controlling a determination condition for the active cell determination in the cell search in accordance with a moving state of the apparatus.

According to the second aspect of the present invention, the determination condition control means in the first aspect obtains, on the basis of a determination result of the active cell determination, a continuous active determination time or consecutive active determination count of a cell determined as an active cell by the active cell determination, and identifies the moving state in accordance with the continuous active determination time or consecutive active determination count.

According to the third aspect of the present invention, when the moving state is a stop/slow moving state, and a cell which has been determined as an active cell becomes the determination target cell again, the determination condition control means in the first main aspect variably controls the determination condition so as to make it easier for the determination target cell to be determined as an active cell by the active cell determination, whereas when the moving state is a fast moving state, and a cell other than a cell which has been determined as an active cell becomes the determination target cell, the determination condition control means variably controls the determination condition so as to make it easier for the determination target cell to be determined as an active cell by the active cell determination.

According to the fourth aspect of the present invention, the determination condition control means in the first main aspect identifies the moving state in accordance with reception quality of a reception signal from the determination target cell.

According to the fifth aspect of the present invention, when the moving state is a stop/slow moving state and the cell having the reception quality becomes the determination target cell again, the determination condition control means in the fourth aspect variably controls the determination condition to make it easier for the determination target cell to be determined as an active cell by the active cell determination, whereas when the moving state is a fast moving state and a cell other than the cell having the reception quality becomes the determination target cell again, the determination condition control means variably controls the determination condition to make it easier for the determination target cell to be determined as an active cell by the active cell determination.

In order to achieve the above object, according to the fifth aspect of the present invention, there is provided a cell search control method for a mobile communication terminal method which is used as a mobile station in a cellular mobile communication system using a CDMA scheme, and executes a cell search (active cell determination) to determine whether a cell (determination target cell) detected on the basis of a reception signal is an active cell to which the apparatus should connect a radio link, comprising the determination condition control step of variably controlling a determination condition for the active cell determination in the cell search in accordance with a moving state of the apparatus.

In order to achieve the above object, according to the sixth aspect of the present invention, there is provided a program for causing a computer to execute a cell search control method for a mobile communication terminal program which is used as a mobile station in a cellular mobile communication system using a CDMA scheme, and executes a cell search (active cell determination) to determine whether a cell (determination target cell) detected on the basis of a reception signal is an active cell to which the apparatus should connect a radio link, comprising the determination condition control step of variably controlling a determination condition for the active cell determination in the cell search in accordance with a moving state of the apparatus.

The present invention has the following functions. If the moving state of a mobile station is recognized as a stop/slow moving state, a determination condition for active cell determination for determining whether a determination target cell detected on the basis of a reception signal is an active cell is controlled such that an active cell which has been determined as a cell that should connect a radio link to the mobile station is continuously held as an active cell. If the moving state of a mobile station is recognized as a fast moving state, a determination condition for active cell determination is controlled such that a cell other than an active cell which has been determined as a cell that should connect a radio link to the mobile station is added as an active cell.

Suppression of a deterioration in communication quality and a reduction in power consumption can be attained by controlling a determination condition for active cell determination in a cell search in accordance with the moving state of a mobile station in this manner. The present invention has the effect of holding high communication quality and reducing power consumption. This is because a determination condition for active cell determination in a cell search is variably controlled in accordance with the moving state of a mobile station, and a determination condition can be variably controlled to perform proper determination in accordance with the current moving state of a mobile station. This makes it possible to suppress a deterioration in communication quality and maintain high communication quality, allowing a reduction in transmission power of the mobile station by transmission power control. Therefore, the power consumption of the mobile station can be reduced.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the arrangement of the cell search processing section of a conventional demodulation circuit in a mobile station used in a cellular mobile communication system using the CDMA scheme;

FIG. 2 is a flow chart showing the operation of an active cell determining section 4 in FIG. 1;

FIG. 3 is a block diagram showing the arrangement of the cell search processing section of a demodulation circuit in a mobile communication terminal apparatus according to the present invention;

FIG. 4 is a flow chart showing the first embodiment of the determination condition control method of the present invention;

FIG. 5 is a flow chart showing the second embodiment of the determination condition control method of the present invention; and

FIG. 6 is a flow chart showing the third embodiment of the determination condition control method of the present invention.

### DETAILED DESCRIPTION OF THE PREFERRED EMBODIMENTS

Several preferred embodiments of the present invention will be described below with reference to the accompanying drawings.

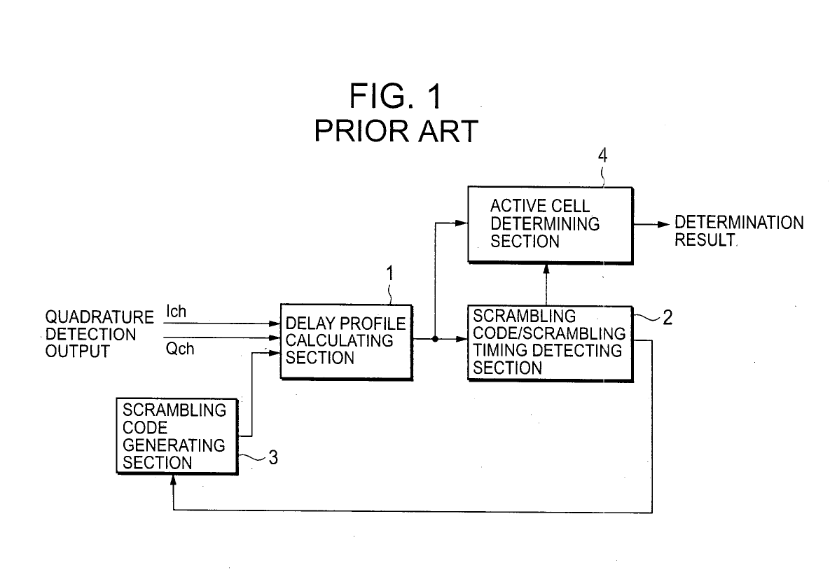

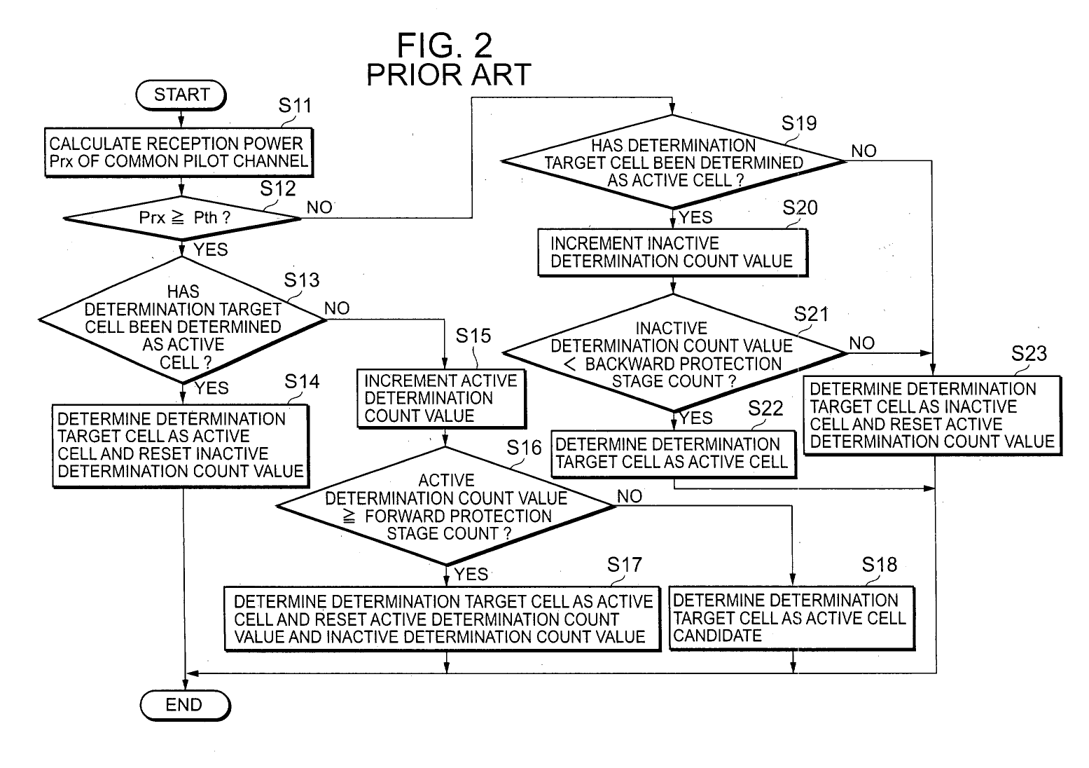

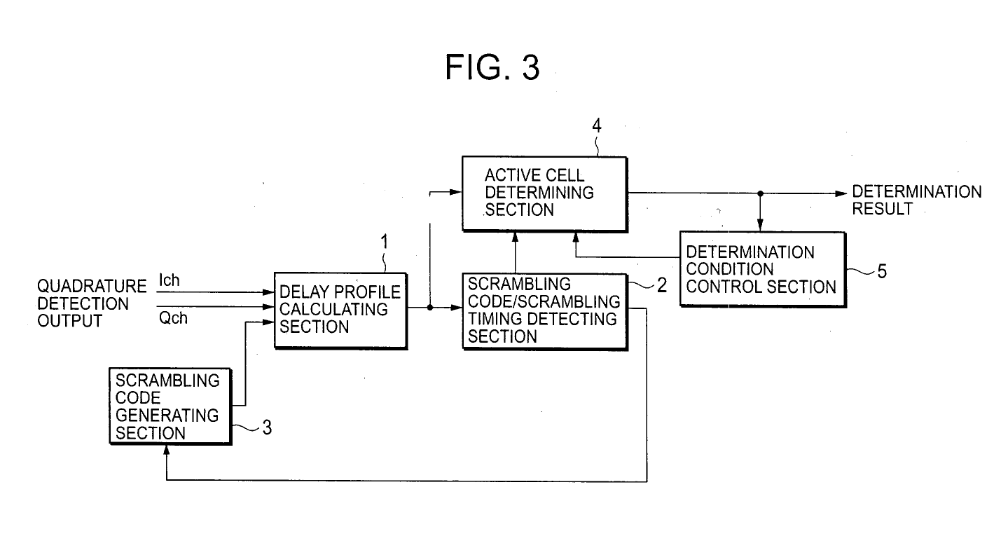

FIG. 3 is a block diagram showing the arrangement of part of a demodulation circuit (a cell search processing section for performing a cell search) in a mobile communication terminal apparatus according to the present invention. The same reference numerals as in FIG. 1 denote the same parts in FIG. 1. The operation of an active cell determining section 4 shown in FIG. 3 is the same as that in the flow chart of FIG. 2 described above. The mobile communication terminal apparatus is applied to a mobile station in a cellular mobile communication system using the CDMA scheme.

The cell search processing section shown in FIG. 3 includes a delay profile calculating section 1, scrambling code/scrambling timing detecting section 2, scrambling code generating section 3, active cell determining section 4, and determination condition control section 5.

The active cell determining section 4 notifies not only a cell transition control section (not shown) for controlling cell transition processing but also the determination condition control section 5 of the determination results obtained in step S14, step S17, step S18, and step S23 in FIG. 2. Note that the determination result notified by the active cell determining section 4 contains information about the time of the determination.

The determination condition control section 5 obtains the time (continuous active determination time) during which an active cell determined as an active cell was continuously determined as an active cell on the basis of the determination result from the active cell determining section 4, and identifies the moving state of the mobile communication terminal apparatus according to the present invention in accordance with this continuous active determination time. The determination condition control section 5 then controls the determination condition in the active cell determining section 4 in accordance with the identified moving state.

More specifically, upon recognizing the moving state as a stop/slow moving state, the determination condition control section 5 changes the determination condition so as to make it less easy to determine this cell as an inactive cell as compared with the case of the normal determination condition (for example, when the backward protection stage count in step S21 in FIG. 2 is N). Upon recognizing the moving state as a fast moving state, the determination condition control section 5 changes the determination condition so as to make it easy to determine an active cell candidate which is not an active cell as an active cell as compared with the case of the normal determination condition (for example, when the forward protection stage count in step S16 in FIG. 2 is N).

A determination condition control method in the determination condition control section 5 shown in FIG. 3 will be described next.

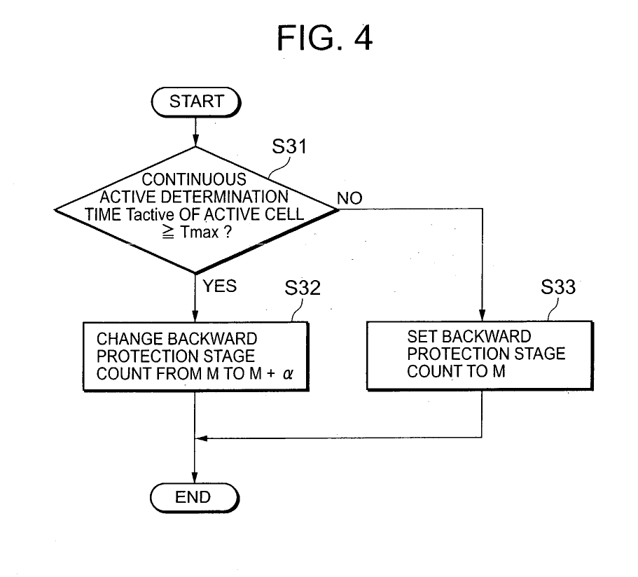

FIG. 4 is a flow chart showing the control operation of the determination condition control section 5, which is the first embodiment of the determination condition control method of the present invention, in a case wherein a reception power level Prx of a determination target cell which has already been determined as an active cell becomes less than a threshold Pth.

Referring to FIGS. 2 and 3, if the reception power level Prx of a determination target cell which has already been determined as an active cell becomes less than the threshold Pth (YES in step S19 in FIG. 2), the active cell determining section 4 sends out an instruction to the determination condition control section 5 to perform operation based on the flow chart shown in FIG. 4. Referring to FIGS. 2 to 4, if, therefore, the reception power level Prx of the determination target cell which has already been determined as an active cell becomes less than the threshold Pth (YES in step S19 in FIG. 2), the determination condition control section 5 compares a continuous active determination time T-active of the active cell with a predetermined determination time threshold T-max in response to the instruction from the active cell determining section 4 (step S31 in FIG. 4).

If it is determined that the continuous active determination time T-active of the active cell is equal to or more than the threshold T-max (YES in step S31 in FIG. 4), it is determined that the mobile station is staying in the active cell and the moving state of the mobile station is a stop/slow moving state. In step S21 in FIG. 2, therefore, the determination condition control section 5 performs control to change the backward protection stage count, which is compared with an inactive determination count value for an active cell, from M to M+α (α>0) (step S32 in FIG. 4).

Since the active cell determining section 4 sets the backward protection stage count to M+α, when the active cell becomes a determination target cell, under the control of the determination condition control section 5, the active cell is less likely to be determined as an inactive cell as compared with the case wherein the backward protection stage count is M. Note that the backward protection stage count set when a cell other than the active cell becomes a determination target cell remains M instead of M+α.

If the continuous active determination time T-active of the active cell is less than threshold T-max (NO in step S31 in FIG. 4), the backward protection stage count is not changed (step S33 in FIG. 4). The active cell determining section 4 therefore sets the backward protection stage count used for the comparison in step S21 in FIG. 2 to M regardless of the type of a determination target cell.

As described above, if a single cell is continuously determined as an active cell for a long period of time, the mobile station recognizes its state as a stop state or slow moving state, and variably controls the determination condition in the active cell determining section 4 so as to hold the cell as an active cell. Obviously, the number of times a given cell which has been determined as an active cell is consecutively determined as an active cell (consecutive active determination count) may be used instead of a continuous active determination time.

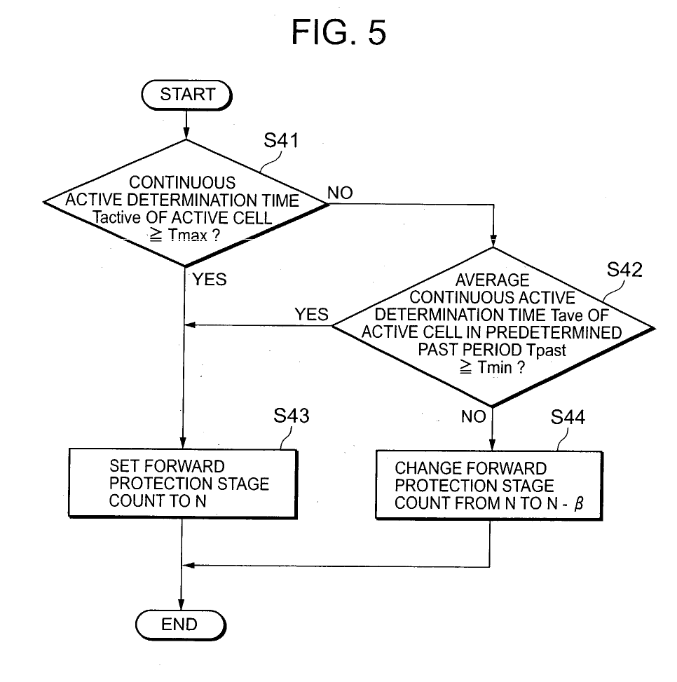

FIG. 5 is a flow chart showing the control operation of a determination condition control section 5, which is the second embodiment of the determination condition control method of the present invention, in a case wherein a cell whose reception power level Prx is equal to or more than a threshold Pth is detected.

Referring to FIGS. 2 and 3, when a cell whose reception power level Prx is equal to or more than the threshold Pth is detected (YES in step S12 in FIG. 2), an active cell determining section 4 sends out an instruction to the determination condition control section 5 to perform operation in accordance with the flow chart shown in FIG. 5.

Referring to FIGS. 2 to 4, therefore, when a cell whose reception power level Prx is equal to or more than the threshold Pth is detected (YES in step S12 in FIG. 2), the determination condition control section 5 compares a threshold T-max with a continuous active determination time T-active of an active cell first in response to the instruction from the active cell determining section 4 (step S41 in FIG. 5). If a plurality of active cell exist, the determination condition control section 5 selects, for example, an active cell with the longest continuous active determination time T-active, and compares the continuous active determination time T-active of this active cell with the threshold T-max.

If the continuous active determination time T-active of this active cell is less than the threshold T-max (NO in step S41 in FIG. 5), the determination condition control section 5 compares a predetermined determination time threshold T-min with an average continuous active determination time T-ave which is the average of the continuous active determination times of the active cell within a predetermined past period T-past (Step S42 in FIG. 5).

If the average continuous active determination time T-ave of this active cell is less than the threshold T-min (NO in step S42 in FIG. 5), since it indicates that the active cell was determined as an inactive cell for a short period of time in the past period T-past, and it is determined that the moving state of the mobile station is a fast moving state, the determination condition control section 5 performs control to change the forward protection stage used in the comparison in step S16 in FIG. 2 from N to N−β (β>0) (step S44 in FIG. 5).

The active cell determining section 4 therefore sets the forward protection stage count to N−β under the control of the determination condition control section 5. This makes it easier for an active cell candidate whose reception power level Prx is equal to or more than the threshold Pth to be determined as an active cell when compared to the case wherein the forward protection stage is N.

If the continuous active determination time T-active of the active cell is equal to or more than the threshold T-max (YES in step S41 in FIG. 5), or the average continuous active determination time T-ave of the active cell is equal to more than the threshold T-min (YES in step S41 in FIG. 5), the forward protection stage count is not changed (step S43 in FIG. 5). The active cell determining section 4 therefore sets the forward protection stage count to N.

As described above, when active cells are switched in a short period of time, the determination condition control section 5 recognizes that the mobile station is in a fast moving state, and variably controls the determination condition in the active cell determining section 4 such that an active cell candidate whose reception power level Prx is equal to or more than the threshold Pth is quickly added as an active cell. Obviously, as in the case shown in FIG. 4, the number of times a given cell which has been determined as an active cell is consecutively determined as an active cell (consecutive active determination count) may be used instead of a continuous active determination time. In addition, an average consecutive active determination count which is the average of consecutive active determination counts of an active cell within the past period T-past may be used instead of an average continuous active determination time.

As described above, according to this embodiment of the present invention, the moving state of a mobile station is identified to control the determination condition for active cell determination in a cell search by monitoring the continuous active determination time of an active cell.

If the continuous active determination time of an active cell is long, i.e., the active cell has been continuously determined as an active cell for a long period of time, it is highly possible that the mobile station is slowly moving and remaining in the active cell. Therefore, the determination condition for active cell determination is variably controlled to allow the active cell to be determined as an active cell afterward. This suppresses the occurrence of active cell determination errors due to shadowing and the like, and hence can prevent a deterioration in communication quality when the mobile station is in a stop/slow moving state.

When the continuous active determination time of an active cell is short, i.e., active cells are switched in a short period of time, it is highly possible that the mobile station is moving fast between different cells. Therefore, the determination condition for active cell determination is variably controlled such that a cell newly detected by a cell search is added as an active cell. This makes it possible to quickly perform cell transition processing and hence prevent a deterioration in communication quality when the mobile station is in a fast moving state.

As described above, according to the present invention, since high communication quality can be maintained, the transmission power of a mobile station can be reduced by transmission power control. This makes it possible to reduce the power consumption of the mobile station.

The third embodiment of the determination condition control method of the present invention will be described next.

In the third embodiment, a determination condition control section 5 controls the determination condition in an active cell determining section 4 by identifying the moving state of a mobile station in accordance with a reception power level instead of the continuous active determination time of an active cell.

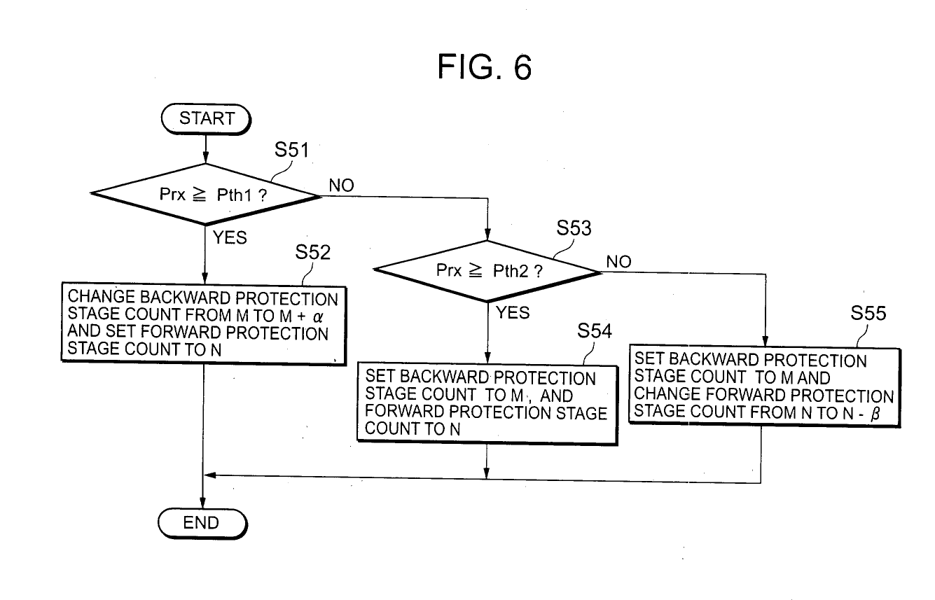

FIG. 6 is a flow chart showing the control operation of the determination condition control section 5 according to the third embodiment. Note that predetermined reception power level thresholds Pth1 and Pth2 in FIG. 6 and a predetermined reception power level threshold Pth in FIG. 2 satisfy Pth1>Pth2>Pth.

Referring to FIGS. 2 and 3, if a cell whose reception power level Prx is equal to or more than the threshold Pth is detected (YES in step S12 in FIG. 2), the active cell determining section 4 sends out an instruction to the determination condition control section 5 to perform operation in accordance with the flow chart shown in FIG. 6, and notifies the determination condition control section 5 of the cell and its reception power level Prx.

Referring to FIGS. 2, 3, and 6, therefore, if a cell whose reception power level Prx is equal to or more than the threshold Pth is detected (YES in step S12 in FIG. 2), the determination condition control section 5 compares the threshold Pth1 with the reception power level Prx notified from the active cell determining section 4 in response to the instruction from the active cell determining section 4 (step S51 in FIG. 6).

If the reception power level Prx is equal to ore more than the threshold Pth1 (YES in step S51 in FIG. 6), since it is determined that the reception power level of the cell notified from the active cell determining section. 4 is sufficiently high, and the mobile station is in a stop/slow moving state, the determination condition control section 5 performs control to change the backward protection stage count to be compared with the inactive determination count for the cell from M to M+α (α>0), but does not change the forward protection stage count (step S52 in FIG. 6).

The active cell determining section 4 therefore sets, under the control of the determination condition control section 5, the backward protection stage count to M+α when the cell becomes a determination target cell. This makes it easier for the cell to be held as an active cell when compared with the case wherein the backward protection stage count is M. Note that the backward protection stage count set when a cell other than the above cell becomes a determination target cell is not M+α but remains M. The active cell determining section 4 sets the forward protection stage to N under the control of the determination condition control section 5.

If the reception power level Prx is less than the threshold Pth1 (NO in step S51 in FIG. 6), the determination condition control section 5 compares the reception power level Prx with the threshold Pth2 (step S53 in FIG. 6).

If the reception power level Prx is equal to or more than the threshold Pth2 (YES in step S53 in FIG. 6), M and N which are the backward protection stage count and forward protection stage count, respectively, are held (step S54 in FIG. 6). The active cell determining section 4 therefore sets the backward protection stage count to M, and the forward protection stage to N.

If the reception power level Prx is less than the threshold Pth2 (NO in step S53 in FIG. 6), since it is determined that the cell notified from the active cell determining section 4 is an unstable cell whose reception power level is low, and the mobile station is in a fast moving state, the determination condition control section 5 performs control to change the forward protection stage count to be used for the comparison in step S16 in FIG. 2 from N to N−β (β−0) but doe not change the backward protection stage count (step S55 in FIG. 6).

The active cell determining section 4 therefore sets the forward protection stage to N−β under the control of the determination condition control section 5. This makes it easier for a newly detected cell whose reception power level Prx is equal to or more than the threshold Pth to be added as an active cell when compared to the case wherein the forward protection stage count is N. The active cell determining section 4 sets the backward protection stage count to M under the control of the determination condition control section 5.

As has been described above, according to the third embodiment of the present invention shown in FIG. 6, the determination condition for active cell determination in a cell search is controlled by identifying the moving state of a mobile station in accordance with the reception power level. Obviously, this determination condition control method can yield the same effects as those of the determination condition control methods according to the first and second embodiments.

Note that the processing operation based on each of the flow charts shown in FIGS. 2 to 6 can be implemented by making a computer serving as a CPU (control section) read out and execute a program stored in advance in a storage medium such as a ROM.

Referring to FIGS. 4 to 6, the determination condition control section 5 variably controls a forward protection stage count and backward protection stage count as determination conditions. However, the same effect can be obtained by variably controlling the reception power level threshold Pth as a determination condition instead of the above conditions. That is, in order to perform control to hold an active cell, the determination condition control section 5 may perform control to decrease the threshold Pth for the active cell. In addition, in order to perform control to quickly add a newly detected cell as an active cell, the determination condition control section 5 may perform control to decrease the threshold Pth for an active cell candidate.

In each embodiment of the present invention, the determination condition for active cell determination is controlled by identifying the moving state of a mobile station on the basis of the continuous active determination time or reception power level. However, another method of identifying a moving state may be used. For example, a moving state can be identified by a known technique of measuring variations in peak timing of a delay profile or the fading pitch of reception power.

What is claimed is:

1. A mobile communication terminal apparatus which is used as a mobile station in a cellular mobile communication system using a CDMA scheme, and executes a cell search (active cell determination) to determine whether a cell (determination target cell) detected on the basis of a reception signal is an active cell to which said apparatus should connect a radio link, comprising
determination condition control means for variably controlling a determination condition for the active cell determination in the cell search in accordance with a moving state of said apparatus.

2. An apparatus according to claim 1, wherein said determination condition control means obtains, on the basis of a determination result of the active cell determination, a continuous active determination time or consecutive active determination count of a cell determined as an active cell by the active cell determination, and identifies the moving state in accordance with the continuous active determination time or consecutive active determination count.

3. An apparatus according to claim 2, wherein said determination condition control means recognizes the moving state a stop/slow moving state if the continuous active determination time or consecutive active determination count is larger than a predetermined threshold, and recognizes the moving state as a fast moving state if the continuous active determination time or consecutive active determination count is smaller than the threshold and an average of the continuous active determination times or consecutive active determination counts in the past is smaller than a predetermined threshold.

4. An apparatus according to claim 2 or 3, wherein when the moving state is a stop/slow moving state, and a cell which has been determined as an active cell becomes the determination target cell again, the determination condition control means variably controls the determination condition so as to make it easier for the determination target cell to be determined as an active cell by the active cell determination.

5. An apparatus according to any one of claims 2 to 4, wherein when the moving state is a fast moving state, and a cell other than a cell which has been determined as an active cell becomes the determination target cell, the determination condition control means variably controls the determination condition so as to make it easier for the determination target cell to be determined as an active cell by the active cell determination.

6. An apparatus according to claim 1, wherein said determination condition control means identifies the moving state in accordance with reception quality of a reception signal from the determination target cell.

7. An apparatus according to claim 6, wherein said determination condition control means recognizes the moving state as a stop/slow moving state if the reception quality is higher than a predetermined threshold, and recognizes the moving state as a fast moving state if the reception quality is lower than a predetermined threshold lower than the threshold.

8. An apparatus according to claim 6 or 7, wherein when the moving state is a stop/slow moving state and the cell having the reception quality becomes the determination target cell again, said determination condition control means variably controls the determination condition to make it easier for the determination target cell to be determined as an active cell by the active cell determination.

9. An apparatus according to any one of claims 6 to 8, wherein when the moving state is a fast moving state and a cell other than the cell having the reception quality becomes the determination target cell again, said determination condition control means variably controls the determination condition to make it easier for the determination target cell to be determined as an active cell by the active cell determination.

10. A cell search control method for a mobile communication terminal method which is used as a mobile station in a cellular mobile communication system using a CDMA scheme, and executes a cell search (active cell determination) to determine whether a cell (determination target cell) detected on the basis of a reception signal is an active cell to which the apparatus should connect a radio link, comprising
the determination condition control step of variably controlling a determination condition for the active cell determination in the cell search in accordance with a moving state of the apparatus.

11. A method according to claim 10, wherein in the determination condition control step, a continuous active determination time or consecutive active determination count of a cell determined as an active cell by the active cell determination is obtained on the basis of a determination result of the active cell determination, and the moving state is identified in accordance with the continuous active determination time or consecutive active determination count.

12. A method according to claim 11, wherein in the determination condition control step, when the moving state is a stop/slow moving state, and a cell which has been determined as an active cell becomes the determination target cell again, the determination condition is variably controlled so as to make it easier for the determination target cell to be determined as an active cell by the active cell determination, and when the moving state is a fast moving state, and a cell other than a cell which has been determined as an active cell becomes the determination target cell, the determination condition is variably controlled so as to make it easier for the determination target cell to be determined as an active cell by the active cell determination.

13. A method according to claim 10, wherein in the determination condition control step, the moving state is identified in accordance with reception quality of a reception signal from the determination target cell.

14. A method according to claim 13, wherein in the determination condition control step, when the moving state is a stop/slow moving state and the cell having the reception quality becomes the determination target cell again, the determination condition is variably controlled to make it easier for the determination target cell to be determined as an active cell by the active cell determination, and when the moving state is a fast moving state and a cell other than the cell having the reception quality becomes the determination target cell again, the determination condition is variably controlled to make it easier for the determination target cell to be determined as an active cell by the active cell determination.

15. A program for causing a computer to execute a cell search control method for a mobile communication terminal program which is used as a mobile station in a cellular mobile communication system using a CDMA scheme, and executes a cell search (active cell determination) to determine whether a cell (determination target cell) detected on the basis of a reception signal is an active cell to which the apparatus should connect a radio link, comprising
the determination condition control step of variably controlling a determination condition for the active cell determination in the cell search in accordance with a moving state of the apparatus.

16. A program according to claim 15, wherein in the determination condition control step, a continuous active determination time or consecutive active determination count of a cell determined as an active cell by the active cell determination is obtained on the basis of a determination result of the active cell determination, and the moving state is identified in accordance with the continuous active determination time or consecutive active determination count.

17. A program according to claim 16, wherein in the determination condition control step, when the moving state is a stop/slow moving state, and a cell which has been determined as an active cell becomes the determination target cell again, the determination condition is variably controlled so as to make it easier for the determination target cell to be determined as an active cell by the active cell determination, and when the moving state is a fast moving state, and a cell other than a cell which has been determined as an active cell becomes the determination target cell, the determination condition is variably controlled so as to make it easier for the determination target cell to be determined as an active cell by the active cell determination.

18. A program according to claim 15, wherein in the determination condition control step, the moving state is identified in accordance with reception quality of a reception signal from the determination target cell.

19. A program according to claim 18, wherein in the determination condition control step, when the moving state is a stop/slow moving state and the cell having the reception quality becomes the determination target cell again, the determination condition is variably controlled to make it easier for the determination target cell to be determined as an active cell by the active cell determination, and when the moving state is a fast moving state and a cell other than the cell having the reception quality becomes the determination target cell again, the determination condition is variably controlled to make it easier for the determination target cell to be determined as an active cell by the active cell determination.
